(19) United States
(12) Patent Application Publication
(10) Pub. No.: US 2025/0195313 A1
(43) Pub. Date: Jun. 19, 2025

(54) SENSORIZED UPPER LIMB EXOSKELETON

(71) Applicant: IUVO S.R.L, Pontedera (PI) (IT)

(72) Inventors: Luca MORELLI, Pontedera (PI) (IT); Matteo MOISE, Pontedera (PI) (IT); Sonia ALBANA, Pontedera (PI) (IT); Francesca DE SIMIO, Pontedera (PI) (IT); Francesco GIOVACCHINI, Pontedera (PI) (IT); Giulio PROFACE, Pontedera (PI) (IT)

(21) Appl. No.: 18/847,366

(22) PCT Filed: Mar. 22, 2023
(86) PCT No.: PCT/IB2023/052820

§ 371 Date: Sep. 16, 2024

Related U.S. Application Data
(60) Provisional application No. 63/322,546, filed on Mar. 22, 2022.

(51) Int. Cl. A61H 1/02

(52) U.S. Cl. CPC A61H 1/0281; A61H 1/0277; A61H 2201/0107; A61H 2201/10; A61H 2201/165; A61H 2201/1676; A61H 2201/5007; A61H 2230/625

(57) ABSTRACT

An upper-body sensorized exoskeleton is configured to interface with external systems, such as FES, advanced cognitive systems, and VR/AR interaction programs, in order to facilitate rehabilitation and assistance of patients affected by upper-limb impairments. The sensorized upper limb exoskeleton delivers anti-gravitational support at the shoulder level, enables upper-limb configuration limits for shoulder and elbow ranges of motion, and reads kinematic data that may be analyzed by users and clinicians. The sensorized upper limb exoskeleton is equipped with electronic processing and communication means that support bidirectional communication between exoskeleton and external systems.

### TECHNICAL FIELD

The system relates to a sensorized upper limb exoskeleton, envisioned for rehabilitation and assistance of users affected by upper-limb impairments based on wearable robotic technology, and a passive shoulder-elbow module to assist the users and clinicians in providing feedback regarding kinematic and physiological data.

### BACKGROUND

The disclosure relates to a sensorized exoskeleton system for assisting a user in exerting efforts configured to engage, when worn by the user, the mutually mobile parts of a joint of the user, and for providing anti-gravitational support at the level of the shoulder. The disclosure further relates to a sensorized exoskeleton system equipped with actuation elements, a sensory system, and an electronic processing and communication unit.

Wearable exoskeletons can assist patients in rehabilitation settings. An exoskeleton may be arranged to transfer loads placed on a user and reduce forces imposed on the body. Stroke patients may use exoskeletons in training settings and during Activities of Daily Living (ADL). There is an increased need for rehabilitation in an aging society, handled by clinical professions and physicians, and in combination with advanced robotic technology.

An exemplary exoskeleton system is arranged for the upper body, including the shoulder and arms, by enhancing performance by reducing forces at the shoulder (e.g., gravitational forces that urge the arms downward), and enabling the user to perform tasks that require shoulder elevation with less effort. The exoskeleton may assist the user in elevating and supporting the user's arms and reduce physical risks and discomfort from tasks carried out above chest height or overhead.

Current wearable exoskeleton robots do not provide a lightweight shoulder-elbow orthosis that offers anti-gravitational support and integrates with functional electrical stimulation (FES), digital twin technology, virtual reality (VR), and augmented reality (AR) systems that may be used in ADLs and rehabilitation tasks. Additionally, exoskeleton robots must be intrinsically safe in design and comply with safety regulations and standards. Existing wearable exoskeletons do not assist shoulder flexion and abduction movements and enable the user to set specific upper-limb configurations through movable robotic joints' end-stops.

Another issue ensures that the assistance provided by the exoskeleton system is commensurate with the user's particular needs and activities. Existing passive systems may provide static or non-dynamic assistive forces, poorly suiting specific movements, postures, or users. Different users may utilize exoskeleton systems in subsequent shifts. Still, existing exoskeleton systems are insufficiently adaptable to the user's specific dimensions, strength, and tasks, leading to poor compliance and poor results across different users. In addition, existing exoskeleton devices may be poorly adapted to allow a user to perform unrelated tasks and must be doffed if such tasks are to be comfortably and effectively executed.

Due to the variability and uncertainty of human movement, current robotic systems are not equipped to integrate with FES systems to provide appropriate assistance to patients as needed. Therefore, there is a need for exoskeletons to offer a full set of kinematic data from embedded sensors and to integrate the communication and control of FES systems to recognize the motor intentions of patients during rehabilitation.

There is a need for a sensorized upper-limb exoskeleton that can interface with FES, advanced cognitive systems, and VR/AR interaction programs to regulate the stimulation response of each muscle, provide cooperative control strategies, ensure safe and robust execution of interaction strategies, and adapt the system in real-time based on an assessment function in combination with a multimodal communication interface. Furthermore, there is a need for a sensorized passive upper limb exoskeleton that can deliver anti-gravitational support at the shoulder level, enable upper-limb configuration limits for shoulder and elbow ranges of motion, and read kinematic data. Additionally, there is a need for a sensorized upper limb exoskeleton equipped with electronic processing and communication means that support bidirectional communication with external systems.

### SUMMARY

The embodiments disclosed herein each have several aspects, no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing rehabilitation systems and exoskeleton devices.

The present disclosure provides a personalized robotics system and related method that may be used in the physical rehabilitation of stroke patients. The system combines a passive upper-limb exoskeleton with embedded sensors to provide a sensorized exoskeleton system. The system offers a lighter, portable exoskeleton in rehabilitation applications. The sensorized exoskeleton may be used at home to monitor the patient's practices in daily and routine training and during ADL tasks. Clinicians may use this information to plan personalized rehabilitation regimes that a patient may perform at home.

According to an embodiment, the passive upper-body exoskeleton is configured to be used in a sensorized exoskeleton system. The exoskeleton is lightweight and portable to enable monitoring in clinical settings and at home. The exoskeleton comprises a physical human-robot interface (pHRi), compensation device, shoulder kinematic chain, rotation cuff, elbow module, and on-board electronics that integrate with an electronic platform.

The pHRi and shoulder kinematic chain facilitate controlled, near-physiological shoulder and elbow range of motion. In one embodiment, the pHRi may be adjustable in length along a user's spine and may also feature a lockable linear guide for shoulder width adjustment. The pHRi features a posterior, horizontal strut that generally extends over a user's left and right scapulae and from a user's left shoulder to a user's right shoulder. The horizontal strut is connected to the linear guide for shoulder width adjustment. A vertical pivot frame is slidably anchored to the linear guide using screws or other fastening elements. The vertical pivot frame generally extends about a second shoulder axis of rotation from a posterior, medial portion of the horizontal strut to a laterally positioned free vertical pivot joint located above the shoulder of a user at a first shoulder axis of rotation. The vertical pivot frame is configured to be substantially vertical to avoid interference with the user to reduce encumbrances.

The free vertical pivot joint allows for movement on a transverse plane and is equipped with an encoder to determine the joint position about a first shoulder axis of rotation. A horizontal arm extends from the free vertical pivot joint and connects to a vertical arm via a lockable hinge. The hinge is used to identify and set the correct position of the shoulder kinematic chain on a user. The horizontal arm comprises a slot that adjusts the relative distance between the free vertical pivot joint at the first shoulder axis of rotation and the shoulder internal-external rotation joint, or rotation cuff, at a third shoulder axis of rotation. The horizontal arm rotates about the first shoulder axis of rotation. The free vertical pivot joint features a limiting torque knob that can fix the slot of the horizontal arm to the vertical pivot frame and to set the relative distance between the free vertical pivot joint at the first shoulder axis of rotation and the shoulder internal-external rotation joint at the third shoulder axis of rotation.

The shoulder kinematic chain also consists of a spring-loaded elevation joint that allows movement on the sagittal and frontal planes. The spring-loaded elevation joint has its center of rotation collocated with the second shoulder axis of rotation. The spring-loaded elevation joint is coupled with a spring-loaded mechanism, or elastic element, enclosed in the compensation device. The spring-loaded elevation joint is also equipped with an encoder to read joint positions about the second shoulder axis of rotation. The shoulder kinematic chain allows for the physical integration of a FES system and enables kinematics monitoring of the shoulder joint by means of a sensor apparatus. The shoulder kinematic chain does not include a collocated joint for arm adduction and abduction at the frontal plane and does not include a parallel remote joint. Rather, the shoulder kinematic chain features a free vertical pivot joint and a spring-loaded elevation joint. The exoskeleton uses the shoulder kinematic chain to reposition the compensation device and uses the spring-loaded elevation joint to allow and assist arm adduction and abduction at the frontal plane.

The compensation device is arranged to provide an auxiliary variable torque at the shoulder level and compensates gravitational forces during shoulder movements on the sagittal and frontal planes. The compensation device is arranged to potentially prolong the duration and intensity of rehabilitation sessions and improve the performance during the execution of the tasks. The compensation device enables kinematic monitoring by means of sensors and guarantees proper cable routing. The compensation device comprises a mechanism, or switch, to shift between assistive and zero-torque modalities. The compensation device features a fixed shaft corresponding to the shoulder elevation axis, or the second shoulder axis of rotation. When the compensation device is switched to the transparent mode, the snap pin is inserted. A lever is fixed to the fixed shaft, with the second shoulder axis and a housing-elastic element axis coincident. Thus, during shoulder elevation, an elastic element cannot generate torque to assist the user because the direction of force of the elastic element is incident with the second shoulder axis. When the compensation device is switched to the assistive mode, the lever is permitted to rotate concerning a lever axis and the lever is aligned with the direction of force of the elastic element. The presence of an inner stroke end limits the stroke of lever, thus enabling torque generation above a specific angle and disabling the torque delivery below the specified angle.

The rotation cuff comprises a circular guide having a center of rotation collocated with the shoulder internal-external rotation axis of a user or third shoulder axis of rotation. The rotation cuff comprises a circular truck and first and second movable end-stops. The circular truck features bearings to enable the circular truck to slide along the circular guide. The rotation cuff is positioned between compensation device and elbow module. The first and second movable end-stops feature degree steps that allow the rotation cuff to customize the range of motion of the user about the third shoulder axis of rotation.

The first and second movable end-stops feature first and second circularly movable tracks and use spring pins to release and stop movement of the movable end-stops. The rotation cuff enables monitoring of kinematic movement by means of encoders and facilitates freedom of movement. The rotation cuff may also feature an encoder that is encased in an encoder housing. The encoder is used to read the joint position of the rotation cuff and is positioned between the first and second movable end-stops. This design provides a compact solution for monitoring internal-external rotation angles.

The elbow module is configured to guarantee freedom of flexion and extension movements at an elbow joint of a user. The elbow module may be arranged to hold a user's upper limb in specific positions to restore physiological posture with respect to desired physiological patterns. The elbow module allows for the physical integration of a FES system and enables kinematics monitoring of the elbow joint using a sensor apparatus. The elbow module features a flexion-extension joint with its center of rotation collocated with the elbow flexion-extension axis of a user or fourth axis of rotation I4. The elbow module may comprise first and second movable end-stops that facilitate tuning of the range of motion of the flexion-extension joint.

The exoskeleton may integrate with an electronic platform for sensor data acquisition, processing, and communication. The electronic platform for sensor data acquisition and processing and communication of the exoskeleton comprises a plurality of sensors, encoders, and IMUs positioned at strategic locations on the portable exoskeleton. The electronic platform may comprise a main control unit, at least one Bluetooth dongle, an ethernet switch, and a battery pack. The electronic platform for sensors data acquisition and processing and for communication also facilitates full software integration with an FES system to provide control of stimulation and acquisition modules through a centralized platform.

The full set of kinematic data obtained from embedded sensors provides relevant input variables to users, healthcare clinicians, and other interactive modules. The electronic platform includes means for data monitoring, such as a graphical user interface on a monitoring computer, to enable real-time visualization of kinematic data acquired by the sensors apparatus, record and store kinematic data, and regulate FES communication and control.

These and other features, aspects, and advantages of the present disclosure will become better understood regarding the following description, appended claims, and accompanying drawings.

### GLOSSARY

As used, the term “proximal” has its ordinary meaning and refers to a location next to or near the point of attachment or origin or a central point, or located toward the center of the body. Likewise, the term “distal” has its ordinary meaning and refers to a location situated away from the point of attachment or origin or a central point, or located away from the center of the body. The term “posterior” also has its ordinary meaning and refers to a location behind or to the rear of another location. Last, the term “anterior” has its ordinary meaning and refers to a location ahead of or to the front of another location.

These anatomical terms follow the user wearing the sensorized upper-limb exoskeleton referring to an anatomical position. An anatomical position is generally defined as the erect position of the body with the face directed forward, the arms at the side, and the palms of the hands facing forward, which is a reference in describing the relation of body parts to one another.

The terms “rigid,” “flexible,” “compliant,” and “resilient” may distinguish characteristics of portions of certain features of the interface system. The term “rigid” should denote that an element of the exoskeleton, such as a frame, is generally devoid of flexibility. Within the context of features that are “rigid,” it should indicate that they do not lose their overall shape when force is applied and may break if bent with sufficient force. The term “flexible” should denote that features are capable of repeated bending such that the features may be bent into retained shapes or the features retain no general shape, but continuously deform when force is applied.

The term “compliant” may qualify such flexible features as generally conforming to the shape of another object when placed in contact therewith, via any suitable natural or applied forces, such as gravitational forces, or forces applied by external mechanisms, for example, strap mechanisms. The term “resilient” may qualify such flexible features as generally returning to an initial general shape without permanent deformation. As for the term “semi-rigid,” this term may connote properties of support members or shells that provide support and are free-standing; however, such support members or shells may have flexibility or resiliency.

The term “zero-torque modality” is used to describe a mode of the compensation device that provides neither obtrusive nor assistive action of the exoskeleton. The zero-torque modality means that approximately zero newton-meters, or less than 0.57 N m, of torque is applied along the full range of shoulder flexion angles.

The term “control unit” is used to describe a main circuit board that is configured to provide power and a suitable electronic interface for the wired connections of all involved sensors. The control unit is part of an electronic platform that supports bidirectional communication with external systems.

The term “encoder” is understood to have its ordinary and usual meaning to one skilled in the art, and, unless specified, may refer to absolute and incremental encoders. The encoder may encompass a device or sensor used to detect positional information. The encoder may be mechanical, optical, magnetic, or electromagnetic induction type.

The term “sensor” is understood to have its ordinary and usual meaning to one skilled in the art. The sensor may refer to a device that measures a physical quantity or quality and converts the measurement into electrical signals that can be read, analyzed, stored, and/or understood by a user, clinician, or another instrument. Additionally, the term “sensorized” is understood to mean fitted or embedded with one or more sensors.

The term “kinematic data” is understood to mean data associated with the motion of the exoskeleton and sensorized parts of the exoskeleton.

The term “cable” should not be understood in a limiting sense and encompasses any flexible elongate structure capable of being wound up and unwound, such as a cord, wire, rope, or line.

The term “user” refers to a person who uses the exoskeleton. The user may be a patient or an operator. The term “clinician” refers to a clinical specialist, supervisor, therapist, doctor, or person with a similar role that assists or oversees the operation of the exoskeleton by the user.

The embodiments of the disclosure are adapted for a human body, and may be dimensioned to accommodate different types, shapes, and sizes of human body sizes and contours. For explanatory purposes, the sensorized exoskeleton system embodiments described correspond to different body sections and are denoted by general anatomical terms for the human body.

The embodiments of the sensorized exoskeleton system may correspond to anterior and posterior body sections defined by an anterior-posterior plane. The anatomical terms described are not intended to detract from the normal understanding of such terms as readily understood by one of ordinary skill in the art of orthopedics, braces, human interfaces, and supports.

### BRIEF DESCRIPTION OF THE DRAWINGS

FIG. 1A illustrates an overview of an exoskeleton embodiment used in a sensorized exoskeleton system including a physical human-robot interface, a shoulder kinematic chain, a compensation device, an elbow module, and a main control unit.

FIG. 1B illustrates the kinematic architecture of an embodiment of a sensorized exoskeleton.

FIG. 2A illustrates an overview of an embodiment of the shoulder kinematic chain.

FIG. 2B is a schematic illustrating an alternative embodiment of the shoulder kinematic chain.

FIG. 2C is a perspective view of a passive rotational joint of the shoulder kinematic chain.

FIG. 2D is a sectional view of the passive rotational joint of FIG. 2C.

FIG. 2E is a schematic illustrating a locking system of the passive rotational joint of FIG. 2C.

FIG. 3A is a sectional view of the free vertical pivot joint of the shoulder kinematic chain.

FIG. 3B is a perspective view of an anterior-posterior adjustment guide for the free vertical pivot joint of the shoulder kinematic chain.

FIG. 4 is a sectional view illustrating an embodiment of the compensation device.

FIG. 5 is a perspective view of the compensation device of FIG. 4.

FIG. 6 is a schematic illustrating internal components of an embodiment of the compensation device.

FIG. 7 is a schematic illustrating internal components of an embodiment of the compensation device with various rotational axes.

FIGS. 8A and 8B are schematics illustrating an embodiment of the shoulder internal-external rotation joint.

FIG. 8C is a cross-sectional view illustrating an embodiment of the circular truck of the shoulder internal-external rotation joint.

FIG. 8D is a schematic illustrating an alternative embodiment of the shoulder internal-external rotation joint.

FIG. 9A is a schematic illustrating an embodiment of the elbow module.

FIG. 9B is a schematic illustrating an alternative embodiment of the elbow module.

FIG. 10 is a simplified block diagram of one embodiment of an electronic platform for a sensorized exoskeleton system.

FIG. 11 illustrates a graphical user interface that allows users to visualize data collected from various sensors of the sensorized exoskeleton system.

FIG. 12 illustrates a motorized actuation strategy for a sensorized exoskeleton system.

### DETAILED DESCRIPTION

### Overview

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. It should be understood, however, there is no intention to limit the disclosure to the specific embodiments disclosed. The purpose is to cover all modifications, alternative constructions, combinations, and equivalents that fall within the spirit and scope of the disclosure.

The embodiments of the disclosure are adapted for a human body, and may be dimensioned to accommodate different types, shapes, and sizes of human body sizes and contours. For explanatory purposes, the sensorized exoskeleton system embodiments described correspond to different sections of a body and are denoted by general anatomical terms for the human body. The term “muscle” is used broadly herein and includes any neuroskeletal muscles (sometimes called “skeletal muscle” or “striated muscle tissue”) of the human body. This can include, for example, muscles of the leg, arm, back, or any other body part.

Described herein is a sensorized exoskeleton that is capable of monitoring the arm kinematics of a user and may interface with external platforms, including FES and AR/VR systems. FES is used broadly herein to refer to sensors, techniques, devices, etc. that stimulate muscles using electrical pulses. FES may be used in combination with electromyography (EMG) to record and interpret biosignals generated by muscles. This includes the use of, for example, sensors and techniques for an electromyogram, for surface EMG, for intramuscular EMG, for implanted EMG sensors, or other sensors that otherwise use the electrical activity or signals generated by any muscle of the human body. Other electronics on-board with the sensory system may include encoders, controllers, IMU devices, batteries, cameras, load cells, reducers, memories, motors, and resistors.

### Sensorized Passive Upper-Body Exoskeleton

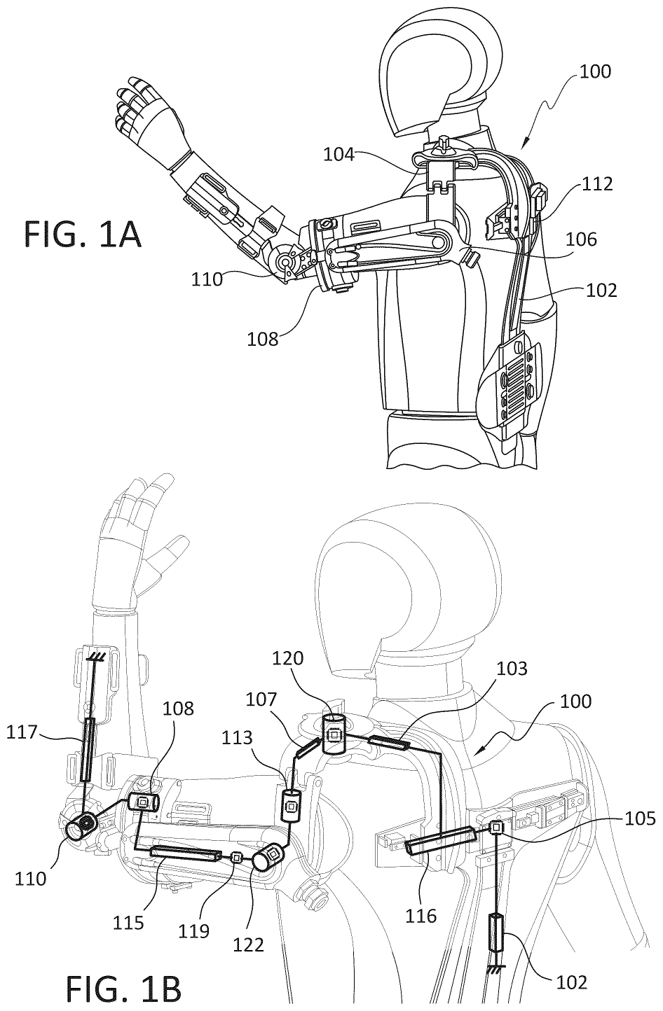

FIG. 1A depicts an embodiment of an upper body exoskeleton 100 that may be used in a sensorized exoskeleton system. It is to be understood that not necessarily all objects or advantages may be achieved under any specific embodiment of the disclosure. Those skilled in the art will recognize that the exoskeleton 100 may be embodied or carried out to achieve or optimize one advantage or group of benefits as taught without achieving other objects or advantages as taught or suggested herein.

The exoskeleton 100 features a physical human-robot interface (pHRi) 102 element devoted to enhancing the interaction between the exoskeleton 100 and a user. In an exemplary embodiment, the pHRi 102 provides trunk and spine stabilization for a user and balances the weight of the unilateral architecture of the exoskeleton 100; however, the exoskeleton 100 could be configured as having a bilateral architecture. The pHRi 102 additionally facilitates safe transmission of assistive forces provided by the compensation device 106. The pHRi 102 may include a rigid or semi-rigid back support panel with padding, a shoulder lace, a balancing posture lace, an arm cuff, one or more forearm cuffs, and fastening means, such as straps or bands, to wrap around the torso of a user. The pHRi 102 may also include discrete regulation means, such as a slidable panel and locking pins, to regulate the length of the pHRi 102 along the spine of the user. Additionally, the pHRi 102 may include an IMU 105, such as a 9-axes inertial module, attached to pHRi trunk support 134.

The exoskeleton 100 features a unique shoulder kinematic chain 104 that provides increased ROM on transverse, sagittal, and frontal planes. The exoskeleton features a shoulder internal-external rotation joint 108 that is configured to guarantee freedom of internal and external rotational movement. The shoulder internal-external rotation joint, or rotation cuff 108, may be arranged to hold a user's upper limb in specific positions to restore the physiological posture of a user concerning desired physiological patterns. The exoskeleton 100 features an elbow module 110 that allows for tunable flexion and extension movements. The elbow module 110 is configured to guarantee freedom of flexion and extension movements at an elbow joint of a user. The elbow module 110 may be arranged to hold a user's upper limb in specific positions to restore the physiological posture of a user with respect to desired physiological patterns.

The exoskeleton 100 features a compensation device 106 that offers assistive force to a user during shoulder movements on sagittal and frontal planes. The compensation device 106 partially compensates for gravitational forces generated by the weight of the upper limb of a user. Additionally, the exoskeleton 100 features an electronic control unit 112 connected to a plurality of sensors and computers and may be part of an exoskeleton electronic platform. The control unit 112 is capable of processing kinematic data received from embedded sensors of the exoskeleton 100 and may interface with the communication and control systems of other FES and VR/HR modules.

FIG. 1B illustrates a schematic of an embodiment of the sensorized exoskeleton 100 and is a conceptualization of a novel kinematic chain. The pHRi 102 features discrete regulation along the spine of a user to accommodate users of different heights and to discretely adjust the length of the pHRi 102. The pHRi 102 includes an IMU 105, such as a 9-axes inertial module, attached to pHRi trunk support 134 to measure a variety of factors, including acceleration, angular rate of the pHRi 102.

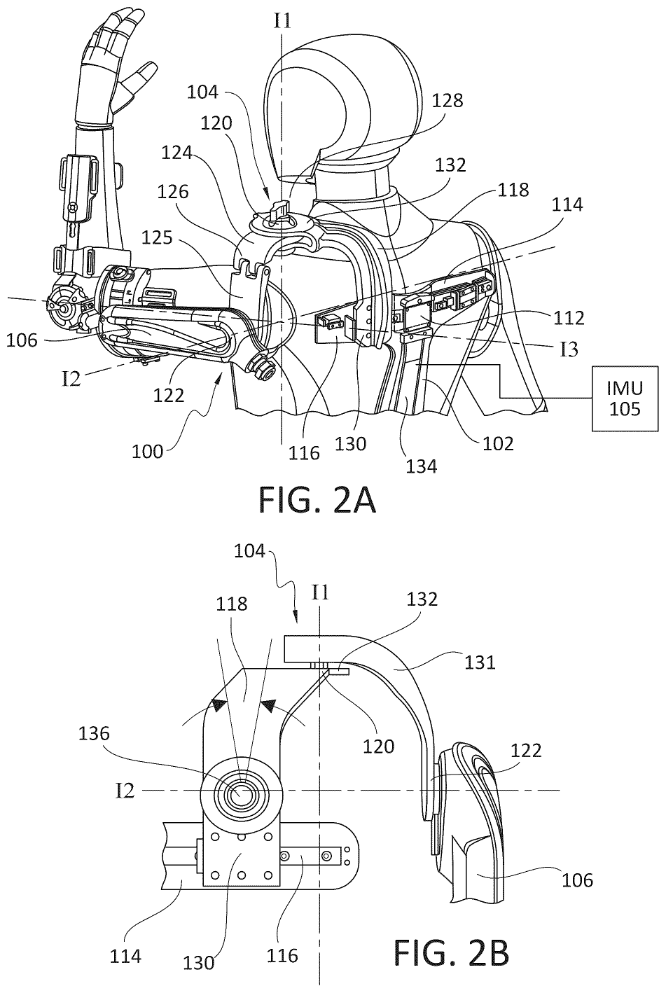

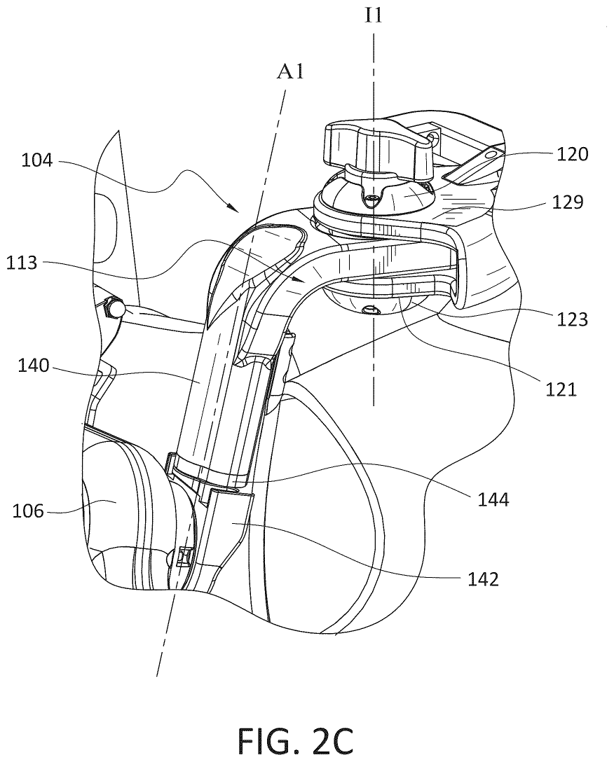

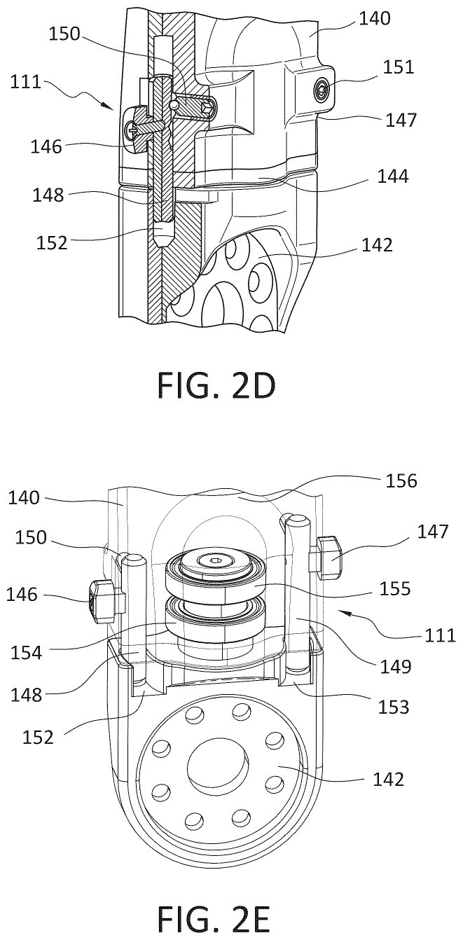

The exoskeleton 100 comprises a linear guide 116 for continuous linear regulation or a passive linear degree of freedom. In an embodiment where the linear guide 116 is configured as a passive linear degree of freedom, permitting linear movement at the shoulder level and on the frontal plane of a user, the linear guide 116 comprises an elastic element, such as an elastic lace or cable, being parallel to a horizontal strut 114 and extending between a vertical pivot frame 118 and pHRi 102, as depicted in FIG. 2A. The elastic, linear degree of freedom of the linear guide 116 provided by an elastic element is implemented to further increase the shoulder range of motion, especially while movements on the transverse plane are performed. This permits a vertical pivot frame 118 to freely slide in the transverse plane and to facilitate elastic return of the vertical pivot frame 118 to a normal resting position.

The exoskeleton 100 further comprises an anterior-posterior adjustment guide 103 to set the anterior-posterior position of a free vertical pivot joint 120. The anterior-posterior adjustment guide 103 accommodates a wide range of anthropometries. The anterior-posterior adjustment guide 103 improves both the exo-kinematic chain alignment with respect to human joints and the wearability of the exoskeleton 100. This adjustment is particularly beneficial for subjects with pathological posture abnormalities (e.g., kyphosis).

In an embodiment, the free vertical pivot joint 120 comprises a continuous regulation joint 107, such as a slot 129 depicted in FIG. 2A, for accommodating continuous adjustment of the distance between the free vertical pivot joint 120 and shoulder internal-external rotation joint 108. Although not explicitly depicted in FIG. 1B, the exoskeleton 100 may comprise a lockable hinge 126, as depicted in FIG. 2A, between the free vertical pivot joint 120 and adjacent rotational joint 113.

In an embodiment, the exoskeleton 100 comprises an adjacent rotational joint 113 disposed between the spring-loaded elevation joint 122 and the free vertical pivot joint 120. The adjacent rotational joint 113 permits passive rotational movement to partially mimic the scapula protraction-retraction degree of freedom. The adjacent rotational joint 113 improves the exo-kinematic chain alignment with respect to human joints during shoulder movements and increases the range of motion of the exoskeleton 100. The adjacent rotational joint 113 is particularly beneficial in specific applications of reaching tasks for ADLs and functional rehabilitation.

The spring-loaded elevation joint 122 implements a spring-loaded degree of freedom. The free vertical pivot joint 120, adjacent rotational joint 113, internal-external rotation joint 108, and elbow module 110 implement passive rotational degrees of freedom. The pHRi 102, arm length adjustment guide 115, and forearm adjustment member 117 facilitate discrete linear regulation to improve wearability and improve alignment with respect to human joints. The exoskeleton 100 may further comprise an IMU 119, such as a 9-axes inertial module, connected to the spring-loaded elevation joint 122.

### Shoulder Kinematic Chain

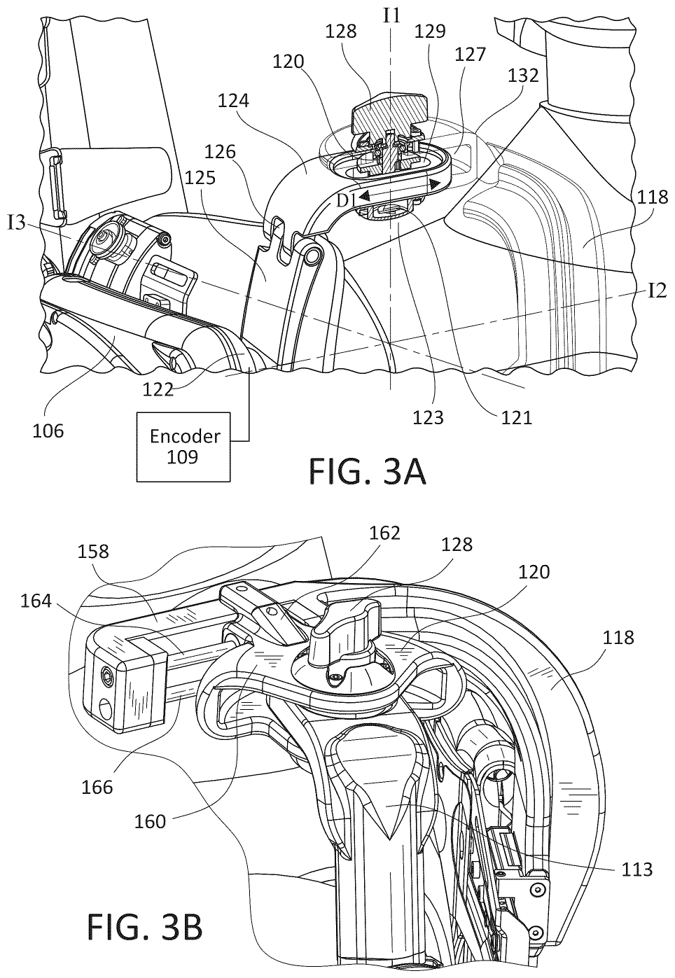

FIGS. 2A, 2B, 3A, and 3B depict an embodiment of a shoulder kinematic chain 104 that may be used with an exoskeleton 100 of a sensorized exoskeleton system. FIG. 2A depicts a shoulder kinematic chain 104 that enables kinematic movement monitoring through encoders, e.g., encoder 109, and facilitates proper overall shoulder mobility. The pHRi 102 features a posterior, horizontal strut 114 arranged to generally extend over a user's left and right scapulae and from a user's left shoulder to a user's right shoulder. A labelled linear guide 116 is fixed to the horizontal strut 114 and extends between opposing ends of the horizontal strut 114. The linear guide 116 may include apertures or markings to indicate the position of vertical pivot alignment with respect to the sagittal plane. A vertical pivot frame 118 is slidably anchored to the linear guide 116 and may be anchored to the linear guide 116 at a specific position using screws or other fastening elements. The vertical pivot frame 118 has a first end 130 that attaches to the linear guide and a second end 132 that is positioned over the shoulder of a user at a first shoulder axis of rotation, or a first axis of rotation, I1. The first end 130 may comprise a slider component to adjust the position of the vertical pivot frame 118 along the linear guide 116.

The vertical pivot frame 118 generally extends about a second shoulder axis of rotation, or horizontal second axis of rotation, I2 from a posterior, medial portion of the horizontal strut 114 to a laterally positioned free vertical pivot joint 120 located above the shoulder of a user at a first axis of rotation I1 and at approximately the frontal plane of the user. The vertical pivot frame 118 may feature holes or apertures at the first end 130 that are generally arrayed along a length perpendicular to the horizontal strut 114 to adjust the height of vertical pivot frame 118 and accommodate different body types and heights of users. Additionally, because the configuration of the vertical pivot frame 118 is such that it is substantially vertical, the vertical pivot frame 118 avoids interference with the user's neck, shoulder, and other elements of the exoskeleton 100.

The free vertical pivot joint 120 allows for movement on a transverse plane and is equipped with an encoder 121 within a housing 123, observed in FIG. 3A, to determine the joint position about a first axis of rotation I1. The free vertical pivot joint 120 may be fixed at a position approximately 150 mm to 185 mm away from the sagittal plane of the user. A horizontal arm 124 extends from the free vertical pivot joint 120 and connects to a vertical arm 125 via lockable hinge 126. The hinge 126 is used to identify and set the correct position of the shoulder kinematic chain 104 on a user. The horizontal arm 124 comprises a slot 129 that allows for adjustment of the relative distance D1 between the free vertical pivot joint 120 at the first axis of rotation I1 and the shoulder internal-external rotation joint 108 at a third shoulder axis of rotation, or a third axis of rotation I3. The horizontal arm 124 rotates about the first axis of rotation I1.

A limiting torque knob 128 is used to fix the horizontal arm 124 to the vertical pivot frame 118 at the free vertical pivot joint 120. In an embodiment, the second end 132 of the vertical pivot frame 118 comprises a recess 127 to receive the horizontal arm 124. The recess 127 allows for movement of the horizontal arm 124 at the free vertical pivot joint 120. The limiting torque knob is used to set the relative distance D1 between the free vertical pivot joint 120 at a first axis of rotation I1 and the shoulder internal-external rotation joint 108 at a third axis of rotation I3. The horizontal arm 124 is provided with a slot 129 through which the limiting torque knob 128 extends and along which the relative distance D1 is regulated parallel to the second axis of rotation I2. The vertical arm 125 connects to the compensation device 106 at the at the spring-loaded elevation joint 122 which is positioned at the second axis of rotation I2.

FIG. 2B depicts an alternative embodiment of the shoulder kinematic chain 104. The horizontal strut 114 features the linear guide 116 so that the vertical pivot frame 118 may be slidably anchored to the linear guide 116 and may be anchored to the linear guide 116 at a specific position by means of screws or other fastening elements. The vertical pivot frame 118 features a posterior rotational shoulder joint 136 that may be used for adding a short-range degree of freedom in phases while the arm is lowered. The posterior rotational shoulder joint 136 may be configured to limit shoulder abduction and adduction and can be lockable to restrict rotation. The vertical pivot frame 118 connects to an adjacent vertical pivot frame 131 at the free vertical pivot joint 120 positioned over the shoulder. The adjacent vertical pivot frame 131 connects to the compensation device 106 at the spring-loaded elevation joint 122, positioned at the second axis of rotation I2.

FIGS. 2C-2E depict an embodiment of the shoulder kinematic chain 104 comprising an adjacent shoulder rotational joint 113 that is connected to the vertical pivot joint 120. The adjacent rotational joint 113 comprises an arm 140 that pivots about an adjacent shoulder axis A1. The pivoting about the adjacent axis A1 enabled by the arm 140 allows the exoskeleton 100 to follow the protraction and retraction movement of the scapula of a user. The adjacent rotational joint 113 comprises a rotational flange 142 that connects to the compensation device 106 and an axial restraint 144 that couples the arm 140 and the rotational flange 142. The adjacent rotational joint 113 is equipped with an absolute encoder 156 and a selective locking system 111.

FIG. 2D depicts a sectional view of the selective locking system 111 that permits the adjacent rotational joint 113 to lock the degree of freedom or to selectively limit the range of motion of the degree of freedom. The selective locking system 111 comprises at least one selector pin 148, 149 that moves up and down with respect to the upper arm of a user. At least one handling selector 146, 147 is anchored to the at least one selector pin 148, 149 that handles and drives the selector pin to lock or unlock the degree of freedom about the adjacent axis A1. The selective locking system 111 also comprises at least one spring plunger 150, 151 that guarantees the correct positioning of the at least one selector pin 148, 149. The selective locking system 111 comprises a shaped socket 152, 153 for each selector pin 148, 149 that is formed on the rotating flange 142 to allow the selective locking system 11 to selectively limit the range of motion about the adjacent axis A1. The selective locking system 111 is easy-to-set and has a negligible impact on the weight and encumbrance of the exoskeleton 100.

FIG. 2E depicts a detailed view of the selective locking system 111. The selective locking system 111 is based on a logic that enables the use of the selective locking system 111 for the possible fabrication of a device for the right or left side. With both selector pins 148, 149 are in an “up” or “non-engaged” position, the degree of freedom of the flange 142 about the adjacent axis A1 is free and unrestricted. When a first selector pin 148 is in the non-engaged position and a second selector pin 149 is in the “down” or “engaged” position, the second selector pin 149 extends into the shaped socket 153 and the flange 142 is restricted to sweep a portion of the angle (half of the entire range of motion) rotating about the adjacent axis A1 and is thus selectively locked. The complementary portion of the angle can be swept when the first selector pin 148 is in the engaged position and the second selector pin 149 is in the non-engaged position. When both selector pins 148, 149 are in the engaged position, the degree of freedom of the flange 142 about the adjacent axis A1 is completely locked. The selective locking system 111 comprises bearing 154, 155 to accommodate rotation of the flange 142 about the adjacent axis A1.

FIG. 3A depicts a sectional view of the free vertical pivot joint and illustrates the lateral dimension fine regulation capability of the shoulder kinematic chain 104. The shoulder kinematic chain 104 features a recess 127 to receive the horizontal arm 124 and limiting torque knob 128. This arrangement allows the horizontal arm 124 to extend and insert a relative distance D1, approximately 0 mm to 25 mm, from the first axis of rotation I1 along the second axis of rotation 12. The shoulder kinematic chain 104 consists of a spring-loaded elevation joint 122 that allows movement on the sagittal and frontal planes. The spring-loaded elevation joint 122 has its center of rotation collocated with the second axis of rotation I2.

The spring-loaded elevation joint 122 is coupled with the compensation device 106 along the second axis of rotation I2. The spring-loaded elevation joint 122 features an encoder 109 to read joint positions about the second axis of rotation I2. The shoulder kinematic chain 104 does not include a collocated joint for arm adduction and abduction at the frontal plane, nor does it have a parallel remote joint. Rather, the shoulder kinematic chain 104 features a free vertical pivot joint 120 and a spring-loaded elevation joint 122. The exoskeleton 100 uses the shoulder kinematic chain 104 to reposition the compensation device 106 and uses the spring-loaded elevation joint 122 to allow and assist arm adduction and abduction at the frontal plane.

FIG. 3B depicts an embodiment of the anterior-posterior adjustment guide 103. The anterior-posterior adjustment guide 103 is part of vertical pivot frame 118 that forms an anterior-posterior guide 158 to modify the position of the first rotational axis I1 forward and backward. The anterior-posterior adjustment guide 103 comprises an anterior-posterior guide 158 and truck 160. In an embodiment, truck 160 comprises a locking member 162, such as a fastener, to secure to the anterior-posterior guide 158. The anterior-posterior guide 158 also comprises at least one bar 164, 166 to permit the truck 160 to linearly translate forward and backward in anterior-posterior directions. The at least one bar 164, 166 may be cylindrical and interface with the truck 160.

### Compensation Device

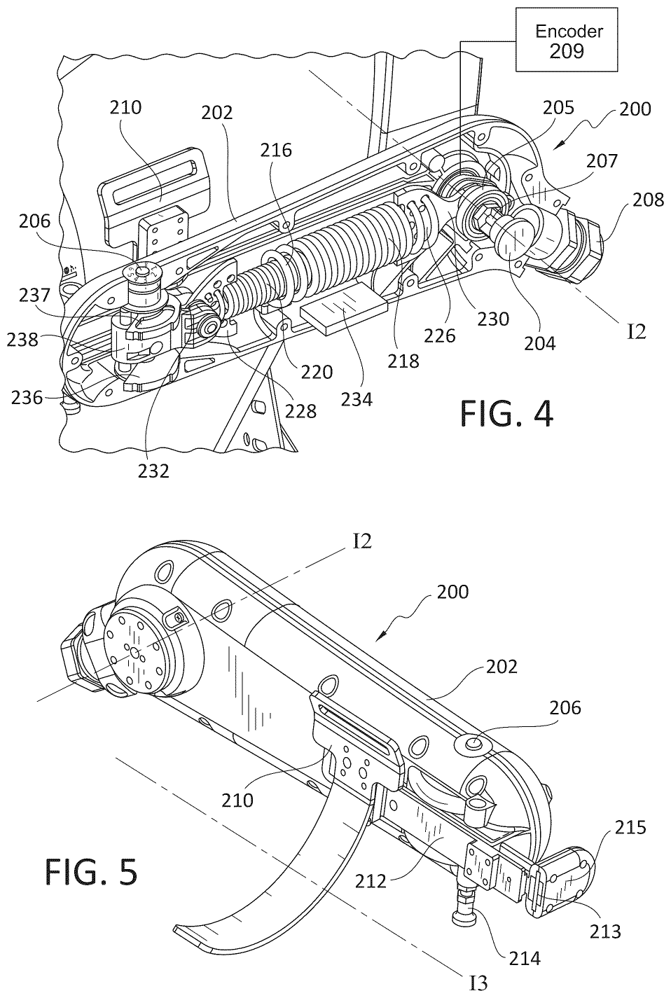

FIGS. 4-6 show perspective views of a compensation device 200. The compensation device 200 is arranged to provide an auxiliary variable torque at the shoulder level and compensates gravitational forces during shoulder movements on the sagittal and frontal planes. The compensation device 200 enables kinematic monitoring using sensors and guarantees proper cable routing. The compensation device 200 comprises a spring-loaded mechanism 205 to switch between assistive and zero-torque modalities.

The modality switch 204 features a snap pin 207 positioned coaxially to the second axis of rotation I2 to switch between a transparent mode and an assistive mode by engaging and disengaging the spring-loaded mechanism 205. When the modality switch 204 is set in the transparent mode position, the snap pin 207 is inserted, and a lever is fixed to a fixed shaft, with shoulder and elastic element axes being coincident. During shoulder elevation, an elastic element cannot generate torque to assist the user because the direction of the elastic element force is incident with shoulder axis I2. The transparent mode is a zero-torque modality that provides neither obtrusive nor assistive action of the exoskeleton.

When the modality switch 204 is set in the assistive mode position, the snap pin 207 is not inserted and the lever is permitted to rotate concerning the lever axis, the lever being aligned with the direction of the elastic element force. An inner stroke end of the fixed shaft 224 allows the compensation device 200 to limit the lever's 222 stroke and enables torque generation above a specific angle (e.g., 20°, 25°, 30°, 35°, or 40°) and disable the torque delivery below that angle. The assistive mode setting provides a two-phase profile that features a zero-torque range followed by an assisted range with a torque-angle curve proportional to the upper limb weight of the user during anti-gravitational movement. The lever, spring-loaded mechanism, and associated axes are described in greater detail below with reference to FIG. 7.

As depicted in FIG. 4, the compensation device 200 has a frame or housing 202 in which features of the compensation device 200 are contained. The compensation device 200 has a modality switch 204 positioned near the shoulder joint of a user or proximate the second axis of rotation I2. The compensation device 200 features an assistance level selector 206 to change the preload of an assistive, elastic element by means of at least one cam 236, 237 and a slider 238. The assistance level selector 206 may be tuned among 8 different levels of torque-angle characteristics. The compensation device 200 features an IMU 234, such as a 9-axes IMU, within the housing 202 to monitor the position of a user's arm. The compensation device 200 features an encoder 209 to read joint positions about the second axis of rotation I2. The compensation device additionally features a cable retaining system 208 to securely fasten sensors' cables, such as IMUs and encoders, and route them toward a main control unit. The cable retaining system 208 minimizes the likelihood of cables catching.

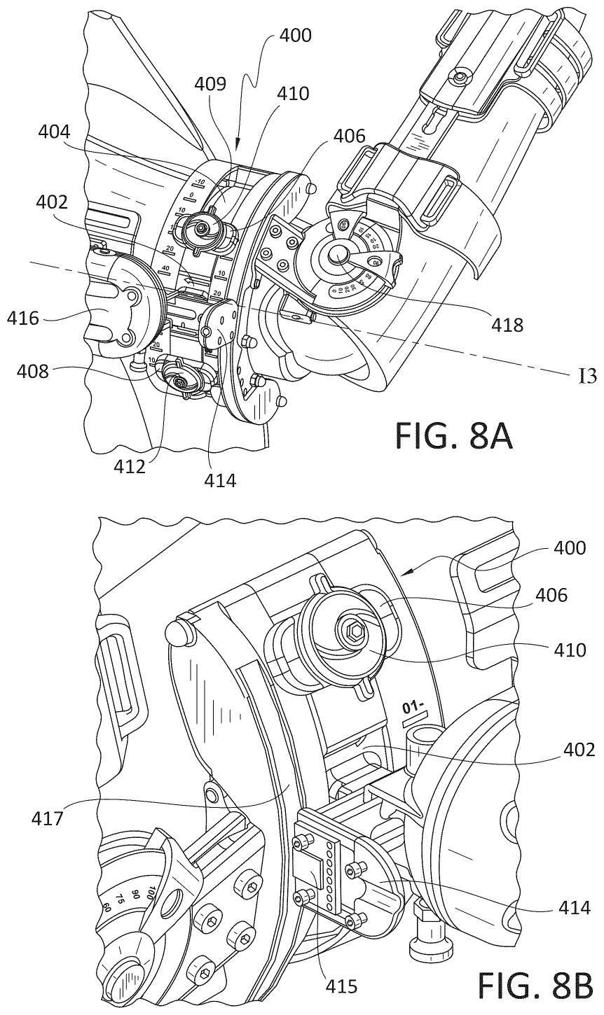

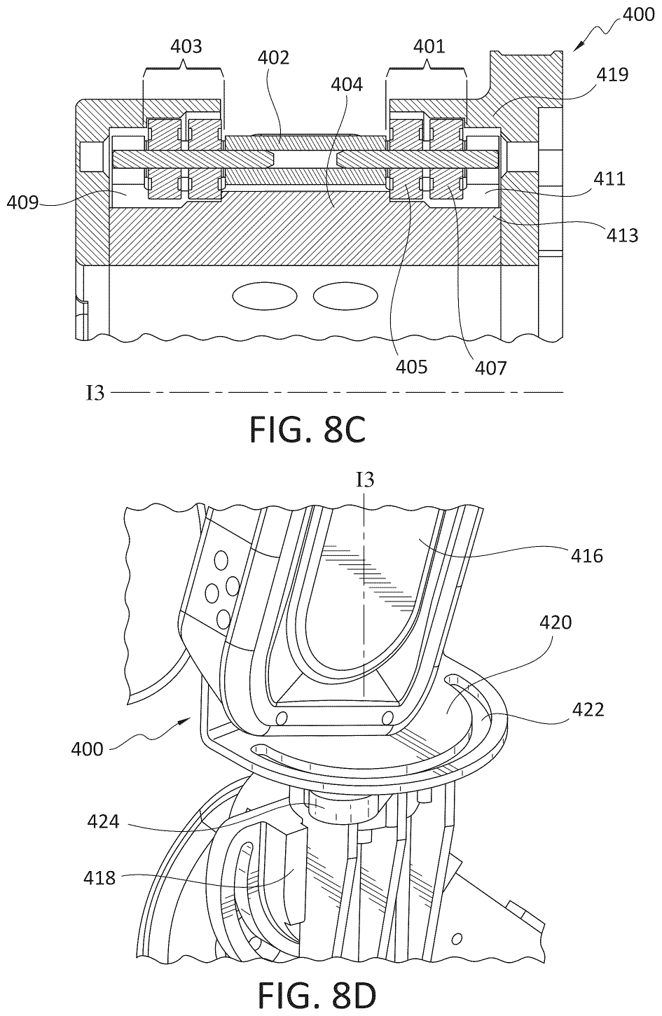

As depicted in FIG. 5, the compensation device 200 features an arm attachment 210 to couple the compensation device 200 to the arm of a user. The arm attachment 210 may feature an integrated D-ring portion that may be used with straps and securing means to couple the compensation device 200 to the arm of a user. The arm attachment 210 may be semi-rigid and feature an arcuate profile that curves about a third axis of rotation I3. The compensation device 200 features an arm length adjustment guide 212 that may function as a linear guide and adjust the length between the shoulder and elbow of a user and is parallel to the third axis of rotation I3. The arm length adjustment guide 212 may be set in a position of approximately 270 mm to 320 mm in length. A spring pin, or linear guide pin 214 is used to set the length of the arm length adjustment guide 212. The linear guide pin 214 may be located at a distal end of the compensation device 200 and arranged to be perpendicular to the arm length adjustment guide 212. In an embodiment, the compensation device 200 comprises a linear guide on a medial side of the compensation device and parallel to the third axis of rotation I3 to allow adjustment of arm attachment 210. The compensation device 200 may also feature an encoder 213 encased in an encoder housing 215 configured to measure the shoulder internal/external rotation joint angle. It is to be understood that the encoder 213 and housing 215 are embodiments of the encoder 415 and housing 414 in FIG. 8B.

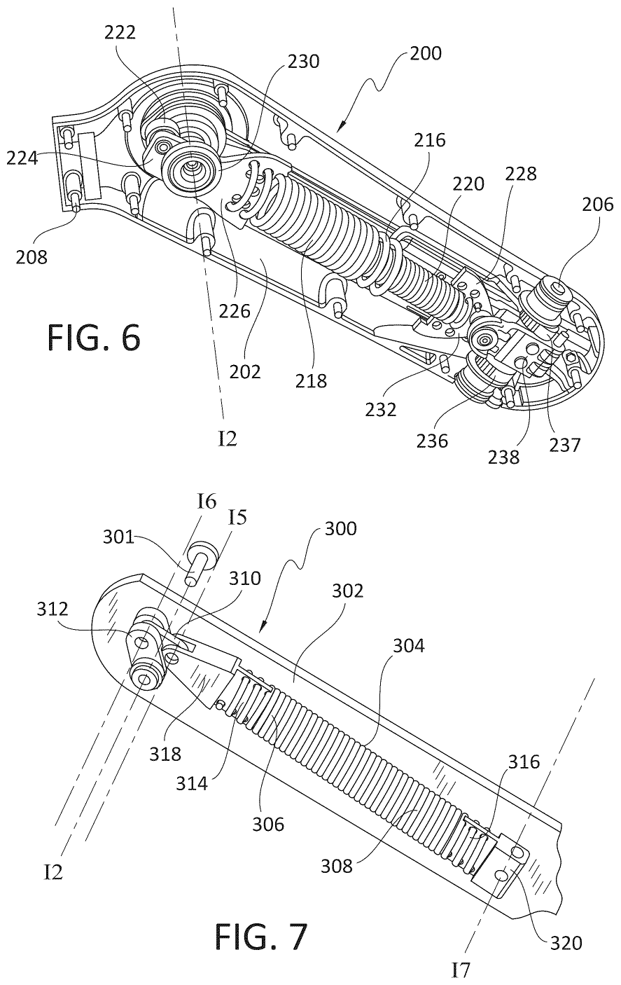

FIG. 6 depicts features of the compensation device 200 that are contained within the housing 202. The compensation device 200 features an elastic element 216 that is perpendicular to a second axis of rotation I2 and has first end 218 and a second end 220. The compensation device 200 features a fixed shaft 224 corresponding to the shoulder elevation axis, or the second axis of rotation I2. A lever 222 is pivotally coupled to the fixed shaft 224. The first end 218 of the elastic element 216 is attached to a first mount 226, and the first mount 226 is connected to a first bracket 230. The second end 220 of the elastic element 216 is attached to a second mount 228, and the second mount 228 is connected to a second bracket 232. The elastic element 216 couples the lever 222 and the housing 202, namely the outer frame of the housing 202 that moves with a user's arm and rotates about the second axis I2.

It is to be understood that compensation devices 200 and 300 are embodiments of compensation device 106. FIG. 7 depicts compensation device 300 in an assistive modality and is a conceptualization of the novel spring-loaded mechanism. The compensation device 300 features a fixed shaft 312 that corresponds to the shoulder elevation axis, or the second axis of rotation I2. When the compensation device 300 is switched to the transparent mode, the snap pin 301 is inserted through the housing 302 of the compensation device 300 along the shoulder elevation axis I2 and a lever 310 is fixed to a fixed shaft 312, with shoulder axis I2 and housing-elastic element axis I5 being coincident.

During shoulder elevation, an elastic element 304 is unable to generate torque to assist the user because the direction of force of the elastic element 304 is incident with shoulder elevation axis I2. The lever-housing axis I7 is located at a distal end of the compensation device 300 and parallel to the housing-elastic element axis I5. When the compensation device 300 is switched to the assistive mode, the lever 310 is permitted to rotate concerning the lever axis I6, the lever 310 being aligned with the direction of force of the elastic element 304 and the snap pin 301 not being engaged to fix the lever 310 and fixed shaft 312.

The presence of an inner stroke end of the fixed shaft 312 limits the stroke of lever 310, enables torque generation above a specific angle (e.g., 20°, 25°, 30°, 35°, or 40°), and disables the torque delivery below the specified angle. The first end 306 of the elastic element 304 is attached to a first mount 314, and the first mount 314 is connected to a first bracket 318. The second end 308 of the elastic element 304 is attached to a second mount 316, and the second mount 316 is connected to a second bracket 320. The elastic element 304 couples the lever 310 and the housing 302, namely the outer frame of the housing 302 that moves with a user's arm and rotates about the shoulder elevation axis I2.

### Rotation Cuff

FIGS. 8A-8D depict exemplary embodiments of the rotation cuff 400. It is to be understood that shoulder internal-external rotation cuff 400 is an embodiment of shoulder internal-external rotation joint or rotation cuff 108. The rotation cuff 400 comprises a circular guide 404 that operates as a slider path about the shoulder internal-external rotation axis of a user or third rotational axis I3. The circular guide defines curved channels 409, 411 for guiding and receiving a circular truck 402 and moveable end-stops 406, 408. The circular truck 402 has a center of rotation collocated with the third rotational axis I3. The rotation cuff 400 is positioned between compensation device 416 and elbow module 418.

The first and second movable end-stops 406, 408 feature 10-degree steps that allow the rotation cuff 400 to customize the range of motion of the user about the third rotational axis I3. The first and second movable end-stops 406, 408 feature first and second circularly movable tracks 410, 412 and use spring pins to release and stop movement of the movable end-stops 406, 408. The movable tracks 410, 412 may feature indicators or markers to specify whether the movable end-stops 406, 408 are in a free or locked position.

The circular truck 402 features one or more coupled bearings 401, 403 to enable the circular truck 402 to slide along the circular guide 404. FIG. 8C depicts an exemplary embodiment of the coupled bearings 401, 403 of circular truck 402 and channels 409, 411 of circular guide 404. FIG. 8C depicts coupled bearings 401 of circular truck 402 configured so that a first bearing 405 contacts a bottom surface 413 of the channel 411, and a second bearing 407 contacts a top surface 419 of the channel 411. This configuration facilitates low friction and avoids backlash. A similar configuration of coupled bearings 403 and channel 409 to that of coupled bearings 401 and channel 411 is observed in FIG. 8C. Those skilled in the art will recognize that the coupled bearings 401 for the circular truck 402 may be substituted with suitable component that bear friction and facilitates rotation and movement.

The circular truck 402 is configured to connect with various embodiments of compensation device 106. In an exemplary embodiment, the circular truck 402 connects with the arm length adjustment guide 212 of the compensation device 200 depicted in FIG. 5. One of ordinary skill in the art would understand that there are countless ways in which the circular truck 402 can be attached to the compensation device 106 such as, for example, adhesive, screw, or straps. Additionally, one of ordinary skill in the art would appreciate that components of the rotation cuff 400 can be made of any suitable material. In an exemplary embodiment, the circular truck 402 is made from a metallic element, such as aluminum, and the circular guide 404 comprises a plastic material.

The rotation cuff 400 enables monitoring of kinematic movement using at least one encoder and facilitates freedom of movement. The rotation cuff 400 features an encoder 415 encased in an encoder housing 414. The encoder 415 is used to read the joint position of the rotation cuff 400 and is positioned between the first and second movable end-stops 406, 408. The encoder 415 may use a magnetic scale 417 positioned on the rotation cuff 400 to obtain kinematic data. This design provides a compact solution for monitoring internal-external rotation angles. The moveable end-stops 406, 408 provide a system with the option to tune the range of motion of a user by limiting or completely locking internal-external rotation of the shoulder joint. Additionally, the reset of the initial joint position of the rotation cuff 400 may be managed via software associated with the electronic platform.

FIG. 8D depicts an alternative embodiment of shoulder internal-external rotation cuff 400. The rotation cuff 400 comprises a base member 420 featuring a curved slot 422. The curved slot 422 is configured to guide a prominence 424 of the elbow module 418 to rotate about a third rotational axis I3. The base member 420 connects to both the compensation device 416 and elbow module 418. The base member 420 may extend along a medial side of the compensation device 416. The rotation cuff 400 has a center of rotation collocated with the third rotational axis I3, and the shoulder internal-external rotation axis of a user is not collocated with the third rotational axis 13. The prominence 424 may include a pin or projection member that extends into or through the curved slot 422. The curved slot 422 may also feature movable end-stops, screws, or other fasteners to limit the range of motion of the rotation cuff 400 about the third rotational axis.

### Elbow Module

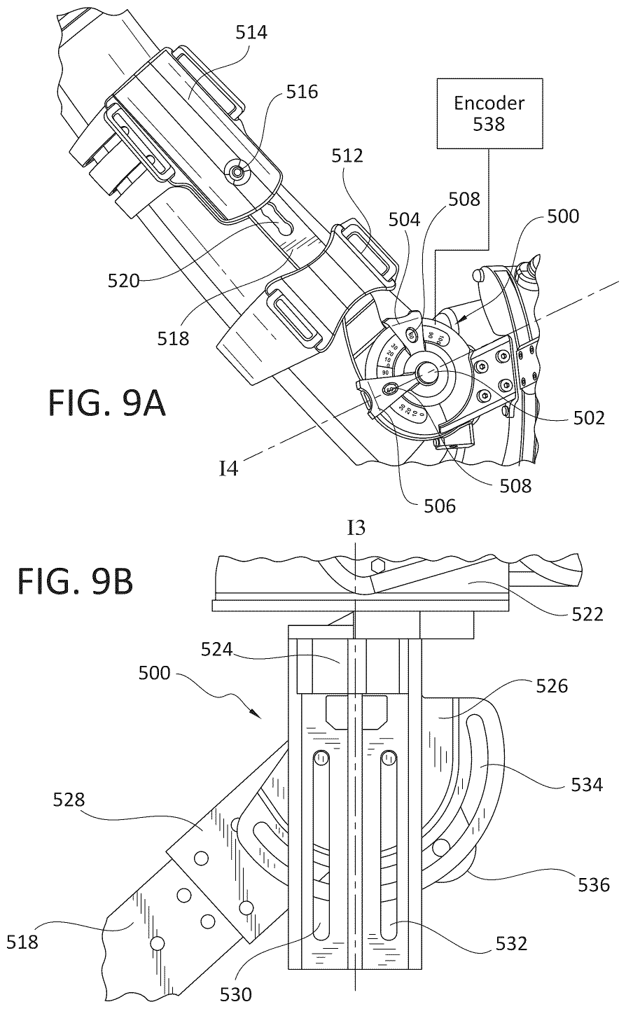

FIG. 9A depicts a preferred embodiment of the elbow module 500. It is to be understood that elbow module 500 is an embodiment of elbow module 110. The elbow module 500 is configured to guarantee freedom of flexion and extension movements at an elbow joint of a user. The elbow module 500 may be arranged to hold a user's upper limb in specific positions to restore the physiological posture of a user with respect to desired physiological patterns. The elbow module 500 allows for the physical integration of a FES system and enables kinematics monitoring of the elbow joint by means of a sensor apparatus.

The elbow module 500 facilitates effective integration of an encoder 538 and proper routing of sensors' cables. The elbow module 500 features a flexion-extension joint 502 with its center of rotation collocated with the elbow flexion-extension axis of a user or fourth axis of rotation I4. The elbow module 500 comprises first and second movable end-stops 504, 506 that facilitate tuning of the flexion-extension joint 502. The movable end-stops 504, 506 may tune the flexion-extension joint to a specific angle or a range of angles between 0 and 105 degrees of flexion. The movable end-stops 504, 506 may also comprise one or more apertures 508 to indicate the position or specific angles of the degrees of flexion.

The elbow module 500 features a semi-rigid or rigid strut 518 that extends from the elbow flexion-extension joint 502 and supports a user's forearm. The strut 518 is configured to interface with a first forearm attachment member 512 and a second forearm attachment member 514. The first forearm attachment member 512 is configured to curve about the forearm of a user and may comprise D-ring attachment members that may engage with straps, belts, or other fastening means to further support the arm of a user. The strut 518 also features an aperture 520 to adjust forearm length using the second forearm attachment member 514.

A forearm adjustment member 516 is used to lock the position of the second forearm attachment member 514 along the strut 518. The forearm adjustment member 516 may comprise a pin, screw, or other fastening member to engage with the aperture 520. The aperture 520 may feature grooves or cavities along the length of the strut 518 that correspond to the forearm adjustment member 516. The second forearm attachment member 514 is configured to curve about the forearm of a user and may comprise D-ring attachment members that may engage with straps, belts, or other fastening means to further support the arm of a user.

FIG. 9B depicts an alternative embodiment of elbow module 500. A first member 524 of the elbow module 500 connects to shoulder internal-external rotation cuff 522 at a third rotational axis I3. The first member 524 features linear slots 530, 532 that allow for arm length adjustment along the third rotational axis I3. The elbow module 500 comprises a second member 526 that features a curved slot 534 that allows for elbow flexion and extension. The curved slot 534 has center point that is collocated with the elbow flexion-extension rotation axis of a user. A third member 528 of the elbow module 500 features a prominence 536 configured to engage the curved slot 534. The curved slot 534 is configured to guide the prominence 536 to rotate about the elbow flexion-extension rotation axis of a user or fourth rotational axis I4. The third member 528 may connect to an adjustable strut 518 that is configured to support the forearm of a user.

### Electronic Platform

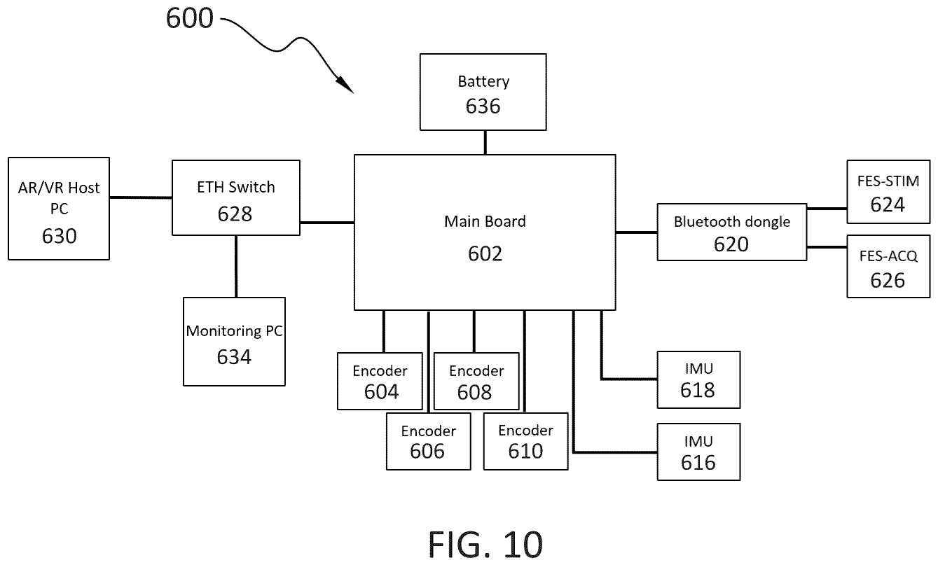

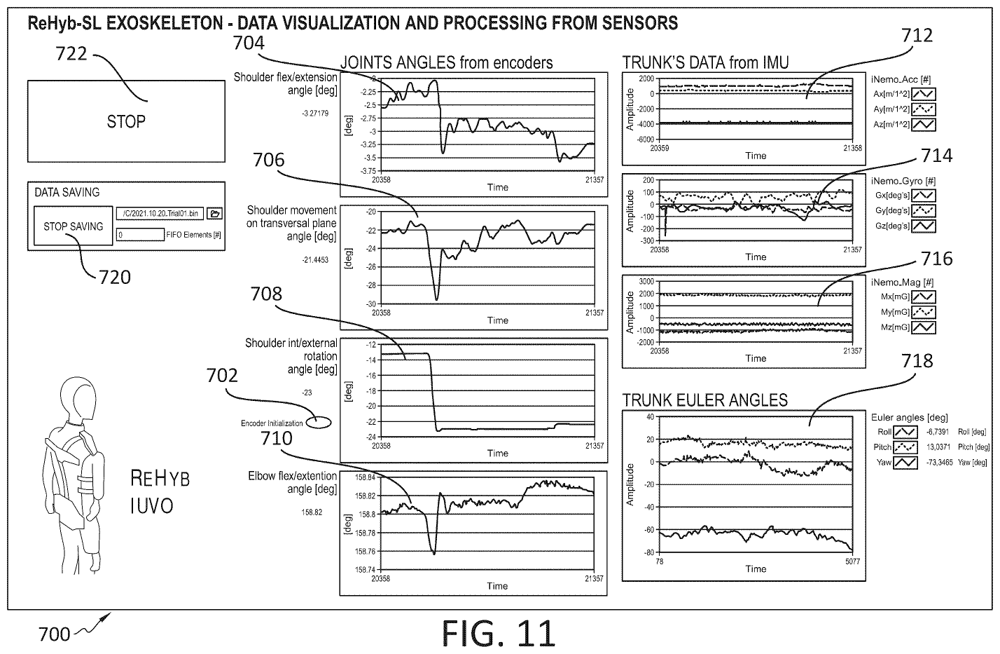

It is to be understood that electronic platform 600 can be integrated with exoskeleton 100 to make up a sensorized exoskeleton system and/or method for interfacing the exoskeleton 100 and electronic platform 600, and control unit 602 is an embodiment of control unit 112. FIG. 10 is a block diagram illustrating one embodiment of electronic platform 600. The electronic platform 600 of the exoskeleton comprises a plurality of sensors, encoders, and IMUs. The electronic platform 600 comprises a main control unit 602, at least one Bluetooth dongle 620, an ethernet switch 628, and a battery pack 636. The battery pack 636 may comprise a high capacity, compact lithium-ion power bank. In an exemplary embodiment, the control unit 602 is a custom carrier-board that features a dual-core processor running a real-time operating system and a field programmable gate array.

The control unit 602 connects to the Bluetooth dongle 620, that manages communication between control unit 602 and external FES modules 624, 626. The Bluetooth dongle 620, is connected to the control unit 602 through SPI or similar interface bus technology. The Bluetooth dongle 620 communicates with FES modules 624, 626 via Bluetooth or other suitable short-range data exchange technology. The ethernet switch 628 is used to ensure communication with an external monitoring computer 634 for Real-time visualization of sensor data. Additionally, the ethernet switch 628 allows communication with an AR/VR host computer 630. The ethernet switch 628 connects to the control unit 602, AR/VR host computer 630 via ethernet communication and to the monitoring computer 634.

Main components of the electronic platform 600 may be embedded in one or more 3D printed cases are remotely connected to the exoskeleton 100 through multi-conductor wiring. The control unit 602 may be connected to a custom breakout board embedded in the exoskeleton 100. Preferably, control unit 602 comprises one or more Surface Mounted Device (SMD) connectors for exoskeleton connection and one or more SMD connectors for sensor interface to reduce encumbrance and weight of the exoskeleton 100.

The electronic platform 600 may have an encoder for each rotational axis of exoskeleton 100. Preferably, the electronic platform 600 features at least three absolute encoders 604, 606, 608 and at least one incremental encoder 610. Free vertical pivot joint 120 may be equipped with absolute encoder 604, spring-loaded elevation joint 122 may be equipped with absolute encoder 606, elbow module 110 may be equipped with absolute encoder 608, and shoulder internal-external rotation joint 108 may be equipped with incremental encoder 610. The encoders 604, 606, 608, and 610 are connected to a main board or control unit 602, preferably via synchronous serial interface (SSI) or similar interface bus. It is to be understood that feedback and kinematic data obtained from the electronic platform 600 may be received by a user or clinician.

### Graphical User Interface

FIG. 11 depicts a Graphical User Interface (GUI) 700 of the electronic platform 600 that is configured to interact with the sensors and electronics of the exoskeleton 100. The electronic platform 600 may also interact with a GUI 700 on the monitoring computer 634 to facilitate real-time visualization of kinematic data acquired by encoders 604, 606, 608, 610 and IMUs 616, 618 and to enable data logging. Additionally, the GUI 700 may interact with FES modules 624, 626. The GUI 700 may display graphs 704,706, 708, 710 of joint angles over time as visualized data collected from encoders 604, 606, 608, 610. As depicted in FIG. 11, the GUI 700 displays a shoulder flexion-extension angle graph 704, a shoulder movement or transversal plane angle graph 706, a shoulder internal-external rotation angle graph 708, and an elbow flexion/extension angle graph 710. The GUI 700 may include a control button 702 or multiple control buttons for encoder initialization. The GUI 700 may also display graphs 712, 714, 716, 718 of data collected from IMUs 616, 618. The IMU trunk data graphs 712, 714, 716 observed in FIG. 11 display variable amplitude over time. The trunk Euler angle graph 718 also displays the amplitude of the trunk's Euler angles over time. The graphs 712, 714, 716, 718 of IMUs 616, 618 may report acceleration, angular rate, magnetic field, and Euler angles.

The GUI 700 may also enable data logging by storing binary files on the control unit 602 or monitoring computer 634. Accordingly, a data saving option 720 may be provided. Data collected with the monitoring computer 634 may be used to assist in planning personalized rehabilitation regimes that a user or patient may perform at home. The GUI 700 may also feature a command 722 to start or stop data visualization. The real-time visualization, data logging, and FES modules of the electronic platform 600 create a digital user twin or virtual representation of the user and sensorized exoskeleton system.

The sensorized exoskeleton system, as described herein, is capable of delivering anti-gravitational support at the shoulder level and offers means to set specific upper-limb configurations by tuning shoulder and elbow ranges of motion. The sensorized exoskeleton system is endowed with a sensory system to monitor kinematic data from the device and is also endowed with an electronic processing and communication unit to support bidirectional communication with external systems. The sensorized exoskeleton system can thus interface with FES, VR/AR, digital twin technology and other feedback systems.

### Motorized Actuation Strategy

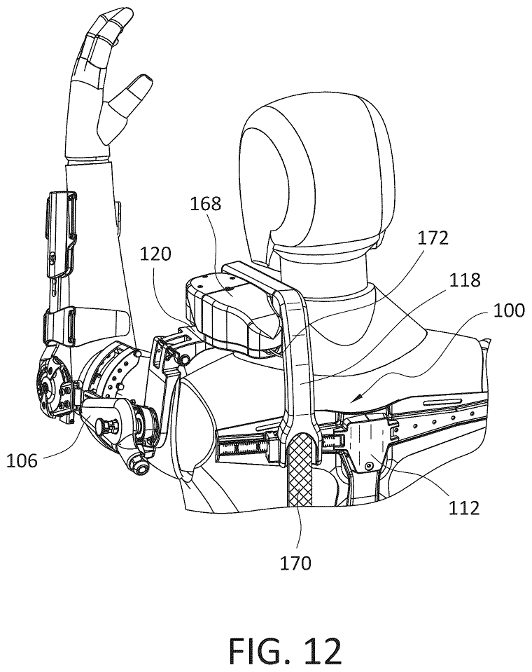

It is to be understood that the disclosed exoskeleton 100 and related tunable joints 108, 110, 120, 122 can be configured to accommodate a motorized or active actuation architecture. The embodiment in FIG. 12 depicts a motorized actuation strategy for the disclosed sensorized exoskeleton 100. The motorized actuation strategy may include one or more actuators 168, placed directly at a joint. The actuation strategy embodiment comprises actuating one or more joints of the exoskeleton 100 (i.e., the free vertical pivot joint 120, spring-loaded elevation joint 122, elbow flexion-extension joint 502). In an embodiment, the exoskeleton 100 comprises a motorized actuator 168 arranged at the free vertical pivot joint 120. The motorized actuator 168 may comprise a digital servomotor, or electric motor, or pneumatic muscle actuator. In an embodiment, the vertical pivot frame 118 is formed as a hollow frame configured to house and route one or more actuator cables 170, 172.

It should be understood that not necessarily all objects or advantages may be achieved under any embodiment of the disclosure. Those skilled in the art will recognize that the embodiments may be embodied or carried out to achieve or optimize one advantage or group of advantages as taught without achieving other objects or advantages as taught or suggested.

Those skilled in the art will recognize the interchangeability of various disclosed features. Besides the variations described, other known equivalents for each feature can be mixed and matched by one of ordinary skill in this art to construct an interface system under principles of the present disclosure.

While the shoulder assist mechanism is briefly described, it is not limited to the depicted embodiments and the interface system may be adapted to accommodate different shoulder assist mechanisms.

1-20. (canceled)

21. A sensorized upper-limb exoskeleton comprising:
a compensation device;
at least one tunable joint arranged to modify upper-limb range of motion of a user;
at least one sensor disposed on the exoskeleton and configured to read kinematic data; and
a control unit configured to interface with an electronic platform and to support bidirectional communication with at least one external system and the at least one sensor.

22. The sensorized upper-limb exoskeleton of claim 21, comprising a shoulder kinematic chain having a free vertical pivot joint at a first axis of rotation and a spring-loaded elevation joint at a second axis of rotation.

23. The sensorized upper-limb exoskeleton of claim 21, comprising a shoulder rotation joint.

24. The sensorized upper-limb exoskeleton of claim 21, comprising an elbow module configured to facilitate integration with functional electrical stimulation modules.

25. The sensorized upper-limb exoskeleton of claim 21, wherein the compensation device comprises a modality switch arranged to convert the compensation device between assistive and non-assistive modalities, and the modality switch having a snap pin positioned coaxially to a second axis of rotation.

26. The sensorized upper-limb exoskeleton of claim 25, wherein, when the modality switch is positioned to the non-assistive modality, the compensation device is switched to a transparent mode, the snap pin is inserted to fix a lever to a fixed shaft, the second axis of rotation and a housing-elastic element axis being coincident, and the second axis of rotation being incident with a direction of force of an elastic element of the compensation device.

27. The sensorized upper-limb exoskeleton of claim 25, wherein, when the modality switch is position to the assistive modality, the compensation device is switched to an assistive mode, the snap pin is removed to uncouple a lever and a fixed shaft, the lever being permitted to rotate with respect to a lever axis, the lever being aligned with a direction of force of an elastic element of the compensation device.

28. The sensorized upper-limb exoskeleton of claim 21, wherein the compensation device further comprises an assistance level selector that may define different assistive levels, the assistance level selector configured to adjust a preload of an elastic element of the compensation device.

29. The sensorized upper-limb exoskeleton of claim 22, wherein the shoulder kinematic chain comprises a vertical pivot frame that extends from a first end of the vertical pivot frame at a trunk support to a second end of the vertical pivot frame at the free vertical pivot joint,
wherein the first end is configured to move along a horizontal linear guide disposed on the trunk support, the second end of the vertical pivot frame being connected to the free vertical pivot joint.

30. The sensorized upper-limb exoskeleton of claim 23, wherein the shoulder rotation joint is connected to the compensation device, the shoulder rotation joint comprising, a circular guide having a center of rotation collocated with a third axis of rotation.

31. The sensorized upper-limb exoskeleton of claim 30, wherein the shoulder rotation joint further comprises a circular truck and at least two movable end-stops.

32. The sensorized upper-limb exoskeleton of claim 24, wherein the elbow module comprises a flexion-extension joint having a center of rotation collocated with a fourth axis of rotation, moveable end-stops, at least one forearm attachment, and at least one sliding strut.

33. A method of providing a personalized upper-limb rehabilitation system comprising:
providing at least one sensor disposed on a sensorized upper-limb exoskeleton of claim 21 and configured to interface with the system and collect kinematic and physiological data;
generating a graphical user interface configured to interact with the sensorized upper-limb exoskeleton, the at least one sensor, and external systems.

34. The method of claim 33, wherein the at least one sensor include both encoders and inertial measurement units to determine joint positions.

35. The method of claim 34, wherein the joint positions determined by the at least one sensor include a shoulder flexion-extension joint angle, a shoulder internal-external rotation joint angle, a shoulder horizontal flexion-extension joint angle, and an elbow flexion-extension joint angle.

36. The method of claim 33, wherein the graphical user interface is configured to provide real-time data visualization, data logging, and external system communication and control, the data logging being enabled to record data collected from the at least one sensor.

37. An exoskeleton comprising a shoulder kinematic chain, the shoulder kinematic chain comprising:
a free vertical pivot joint at a first axis of rotation, wherein the free vertical pivot joint facilitates movement along a transverse plane of a user;
a spring-loaded elevation joint at a second axis of rotation, wherein the spring-loaded elevation joint facilitates movement along sagittal and frontal planes of a user; and
an adjacent rotational joint disposed between the free vertical pivot joint and the spring-loaded elevation joint, wherein the adjacent rotational joint pivots about an adjacent axis and facilitates protraction and retraction of the shoulder kinematic chain.

38. The exoskeleton of claim 37, wherein the adjacent rotational joint comprises a selective locking system.

39. The exoskeleton of claim 37, wherein the adjacent rotational joint comprises a rotating flange anchored to the spring-loaded rotational joint.

40. The exoskeleton of claim 37, wherein the free vertical pivot joint comprises an anterior-posterior adjustment guide to linearly modify a position of the first rotational axis in both anterior and posterior directions.
